(19) United States
(12) Patent Application Publication
(10) Pub. No.: US 2015/0126730 A1
(43) Pub. Date: May 7, 2015

(54) NOVEL COMPOSITION FOR PREPARING POLYSACCHARIDE FIBERS

(71) Applicant: E I DU PONT DE NEMOURS AND COMPANY, Wilmington, DE (US)

(72) Inventor: JOHN P. O'BRIEN, Oxford, PA (US)

(21) Appl. No.: 14/531,143

(22) Filed: Nov. 3, 2014

Related U.S. Application Data
(60) Provisional application No. 61/901,060, filed on Nov. 7, 2013.

(51) Int. Cl. D01F 9/00; C08B 37/00

(52) U.S. Cl. CPC D01F 9/00; C08B 37/0009
USPC 536/119; 264/211.14

(57) ABSTRACT

Solutions formed by combining poly(α(1→3) glucan) with concentrated aqueous formic acid solution, optionally containing methylene chloride, have been shown to produce the formylated form of the poly(α(1→3) glucan). The solutions so formed have been shown to be useful for solution spinning into fiber of poly(α(1→3) glucan) when the spun fiber is coagulated into a coagulation bath. The fibers so produced exhibit desirable physical properties. The poly(α(1→3) glucan) employed was synthesized by the action of a recombinant enzyme prepared via fermentation.

### FIELD OF THE INVENTION

The present invention is directed to a novel composition useful for preparing fibers of poly(α(1→3) glucan), the composition being a solution of a formate-derivatized, or formylated, poly(α(1→3)glucan) in a concentrated aqueous formic acid solution. The poly(α(1→3)glucan) employed is synthesized by the action of a glucosyltransferase enzyme.

### BACKGROUND OF THE INVENTION

Polysaccharides have been known since the dawn of civilization, primarily in the form of cellulose, a polymer formed from glucose by natural processes via β(1→4) glycoside linkages; see, for example, Applied Fibre Science, F. Happey, Ed., Chapter 8, E. Atkins, Academic Press, New York, 1979. Numerous other polysaccharide polymers are also disclosed therein.

Only cellulose among the many known polysaccharides has achieved commercial prominence as a fiber. In particular, cotton, a highly pure form of naturally occurring cellulose, is well-known for its beneficial attributes in textile applications.

It is further known that cellulose exhibits sufficient chain extension and backbone rigidity in solution to form liquid crystalline solutions; see, for example O'Brien, U.S. Pat. No. 4,501,886. The teachings of the art suggest that sufficient polysaccharide chain extension could be achieved only in β(1→4) linked polysaccharides and that any significant deviation from that backbone geometry would lower the molecular aspect ratio below that required for the formation of an ordered phase.

More recently, glucan polymer, characterized by α(1→3) glycoside linkages, has been isolated by contacting an aqueous solution of sucrose with GtfJ glucosyltransferase isolated from Streptococcus salivarius, Simpson et al., Microbiology, vol 141, pp. 1451-1460 (1995). Highly crystalline, highly oriented, low molecular weight films of α(1→3)-D-glucan have been fabricated for the purposes of x-ray diffraction analysis, Ogawa et al., Fiber Diffraction Methods, 47, pp. 353-362 (1980). In Ogawa, the insoluble glucan polymer is acetylated, the acetylated glucan dissolved to form a 5% solution in chloroform and the solution cast into a film. The film is then subjected to stretching in glycerine at 150° C. which orients the film and stretches it to a length 6.5 times the original length of the solution cast film. After stretching, the film is deacetylated and crystallized by annealing in superheated water at 140° C. in a pressure vessel. It is well-known in the art that exposure of polysaccharides to such a hot aqueous environment results in chain cleavage and loss of molecular weight, with concomitant degradation of mechanical properties.

Polysaccharides based on glucose and glucose itself are particularly important because of their prominent role in photosynthesis and metabolic processes. Cellulose and starch, both based on molecular chains of polyanhydroglucose are the most abundant polymers on earth and are of great commercial importance. Such polymers offer materials that are environmentally benign throughout their entire life cycle and are constructed from renewable energy and raw materials sources.

The term “glucan” is a term of art that refers to a polysaccharide comprising beta-D-glucose monomer units that are linked in eight possible ways. Cellulose is a glucan.

Within a glucan polymer, the repeating monomeric units can be linked in a variety of configurations following an enchainment pattern. The nature of the enchainment pattern depends, in part, on how the ring closes when an aldohexose ring closes to form a hemiacetal. The open chain form of glucose (an aldohexose) has four asymmetric centers (see below). Hence there are 2⁴ or 16 possible open chain forms of which D and L glucose are two. When the ring is closed, a new asymmetric center is created at C1 thus making 5 asymmetric carbons. Depending on how the ring closes, for glucose, α(1→4)-linked polymer, e.g. starch, or β(1→4)-linked polymer, e.g. cellulose, can be formed upon further condensation to polymer. The configuration at C1 in the polymer determines whether it is an alpha or beta linked polymer, and the numbers in parenthesis following alpha or beta refer to the carbon atoms through which enchainment takes place.

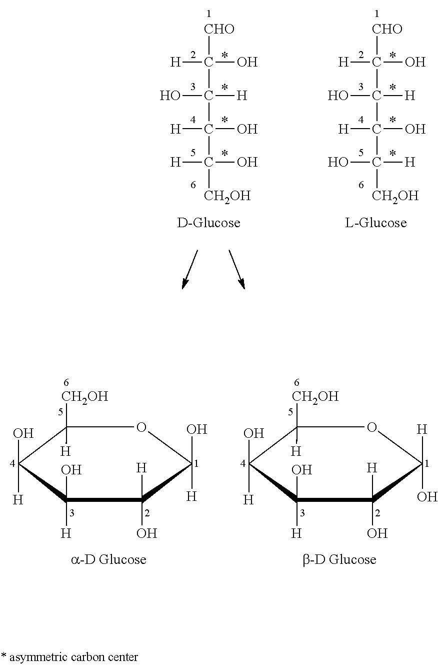

The properties exhibited by a glucan polymer are determined by the enchainment pattern. For example, the very different properties of cellulose and starch are determined by the respective nature of their enchainment patterns. Starch or amylose consists of α(1→4) linked glucose and does not form fibers among other things because it is swollen or dissolved by water. On the other hand, cellulose consists of β(1→4) linked glucose, and makes an excellent structural material being both crystalline and hydrophobic, and is commonly used for textile applications as cotton fiber, as well as for structures in the form of wood.

Like other natural fibers, cotton has evolved under constraints wherein the polysaccharide structure and physical properties have not been optimized for textile uses. In particular, cotton fiber is of short fiber length, limited variation in cross section and fiber fineness and is produced in a highly labor and land intensive process.

O'Brien, U.S. Pat. No. 7,000,000 discloses a process for preparing fiber from liquid crystalline solutions of acetylated poly(α(1→3) glucan). The thus prepared fiber was then de-acetylated resulting in a fiber of poly(α(1→3) glucan).

### SUMMARY OF THE INVENTION

Considerable benefit accrues to the process hereof that provides a highly oriented and crystalline formylated poly (α(1→3) glucan) fiber without sacrifice of molecular weight by the solution spinning of fiber from the novel solution hereof.

In one aspect the present invention is directed to an aqueous spinning solution comprising 85 to 98% by weight of formic acid and a solids content of 5 to 30% by weight of formylated poly(α(1→3) glucan) comprising glucose and formylated glucose repeat units linked by glycoside linkages whereof ≧50% of said glycoside linkages are α(1→3) glycoside linkages; wherein the number average molecular weight of the formylated poly(α(1→3) glucan) is at least 10,000 Daltons; and, wherein the degree of formylation of the formylated poly(α(1→3) glucan) lies in the range of 0.1 to 2.

In another aspect, the present invention is directed to a process comprising forming a spinning solution by dissolving into an aqueous solution of 85 to 98% formic acid, 5 to 20% by weight of the total weight of the spinning solution so formed, of poly(α(1→3) glucan), thereby preparing formylated poly(α(1→3) glucan) comprising glucose and formylated glucose repeat units linked by glycoside linkages whereof ≧50% of said glycoside linkages are α(1→3) glycoside linkages; wherein the number average molecular weight of the poly(α(1→3) glucan) is at least 10,000 Da; and, wherein the degree of formylation of the formylated poly(α(1→3) glucan) so formed lies in the range of 0.1 to 2; causing said solution to flow through a spinneret, forming a fiber thereby; and contacting said fiber with a liquid coagulant.

In another aspect, the present invention is directed to a fiber comprising formylated poly(α(1→3) glucan) comprising glucose and formylated glucose repeat units linked by glycoside linkages whereof ≧50% of said glycoside linkages are α(1→3) glycoside linkages; wherein the number average molecular weight of the formylated poly(α(1→3) glucan) is at least 10,000 Daltons, and wherein the degree of formylation of the formylated poly(α(1→3) glucan) lies in the range of 0.1 to 2.

### BRIEF DESCRIPTION OF THE DRAWING

FIG. 1A is a schematic diagram of an apparatus suitable for air gap or wet spinning of the formylated poly(α(1→3) glucan) fibers hereof.

FIG. 1B depicts in more detail the spray apparatus of FIG. 1A.

### DETAILED DESCRIPTION

When a range of values is provided herein, it is intended to encompass the end-points of the range unless specifically stated otherwise. Numerical values used herein have the precision of the number of significant figures provided, following the standard protocol in chemistry for significant figures as outlined in ASTM E29-08 Section 6. For example, the number 40 encompasses a range from 35.0 to 44.9, whereas the number 40.0 encompasses a range from 39.50 to 40.49.

The term “solids content” is a term of art that refers to the concentration by weight of a solute in a solution. When no chemical reaction takes place in the solution, solids content is simply the percentage by weight of the added solid in the final solution. Thus, if 2 g of NaCl were added to 98 g of water, the solids content would be 2%. However, in the case of the present invention, the formic acid solvent reacts with the added poly(α(1→3) glucan) solute to form formyl ester groups, so that actual solids content will be higher by the weight of the formyl ester groups than that calculated simply by the weight of poly(α(1→3) glucan) added. Solids content is determined from the formula:

$$SC ( \% ) = \frac{Wt ( FG )}{Wt ( FG ) + Wt ( FA ( aq ) )} \times 100$$

where SC represents “solids content,” and Wt(FG), Wt(FA(aq)) are respectively weights of the formylated poly(α(1→3) glucan), and of the aqueous formic acid (FA) solution. The aqueous formic acid solution weight further comprises any contribution from incorporating methylene chloride (MeCl₂) thereinto. The term “solids content” is synonymous with the concentration by weight of formylated poly(α(1→3) glucan) with respect to the total weight of solution.

Percent by weight is represented by the term “wt-%.”

A polymer, including glucan, and poly(α(1→3) glucan) in particular, is made up of a plurality of so-called repeat units covalently linked to one another. The repeat units in a polymer chain are diradicals, the radical form providing the chemical bonding between repeat units. For the purposes of the present invention the term “glucose repeat units” shall refer to the diradical form of glucose that is linked to other diradicals in the polymer chain, thereby forming said polymer chain.

The term “glucan” refers to polymers, including oligomers and low molecular weight polymers that are unsuitable for fiber formation. For the purposes of the present invention, the glucan polymer suitable for the practice of the invention is a poly(α(1→3) glucan) or formylated poly(α(1→3) glucan), characterized by a number average molecular weight of at least 10,000 Daltons, preferably at least 40,000. No practical upper limit to the molecular weight has been determined. In general, it is known in the art that the properties of fibers prepared from a higher molecular weight batch of a given fiber-forming polymer will be superior to the properties of fibers prepared from a lower molecular weight batch of the same fiber forming polymer. However, as molecular weight increases above 100,000 Da, more particularly above 200,000 Da, and even more particularly, above 500,000 Da, crystallization rates can slow down enough to alter properties of the spun fiber. Additionally, higher molecular weights are more difficult to dissolve, and tend to form more viscous solutions, making them harder to spin. Therefore, the practitioner hereof needs to make a trade-off in molecular weight between processability and spun fiber properties.

Upon contacting the formic acid solution, the poly(α(1→3) glucan) suitable for use in the invention hereof undergoes conversion to the formyl ester of poly(α(1→3) glucan) by reaction of the pendant hydroxyl groups in the repeat units with the formic acid. The formylated poly(α(1→3) glucan) thus prepared is characterized by a degree of formylation (DOF) in the range of 0.1 to 2, preferably 0.5 to 1.5. The term “formylation” is a term of art referring to the reaction of a hydroxyl group in the glucan with formic acid, according to the following reaction:

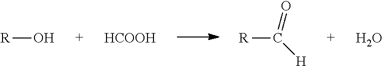

wherein R is the polymer backbone.

In the case of the poly(α(1→3) glucan) suitable for use in the process of the invention, each cyclic hexose repeat unit offers three hydroxyls for potential reaction to form the formate according to the above reaction scheme. The term “degree of formylation” refers to the average number of available hydroxyl sites in each repeat unit that have actually undergone reaction to the formate. The theoretical maximum degree of formylation of a suitable PAG polymer molecule can undergo is 3—that is, every single hydroxyl site in the polymer would have undergone conversion to the formyl ester. In practice, it is difficult to achieve a degree of formylation greater than 2.

For the purposes of the present invention, the DOF is determined by nuclear magnetic resonance (NMR) according to the method provided infra.

According to the present invention, suitable formylated poly(α(1→3) glucan) polymers have undergone formylation to the degree of 0.1 to 2, preferably 0.5 to 1.5. A DOF of 0.1 means that on the average one hydroxyl site per ten repeat units has reacted with formic acid to form the formyl ester. A DOF of 2 means that on the average 20 hydroxyl sites per ten repeat units have reacted to form the formyl ester.

In general, the higher the DOF, the higher the possible solids content in the spinning solution, up to around 30% solids. In general, stable solutions with higher solids content provide better spinning performance. DOF depends upon the concentration of formic acid in the solution, and on the time allowed for reaction to take place. It is expected that DOF above 2 might be achieved when sufficient time, mixing, and so forth are allowed for, however, in practice the rate of reaction to achieve DOF above 2 has been found to be unacceptably slow. It is believed that formylated glucan with a DOF above 2 might provide yet better spinning performance than has so far been achieved.

In one aspect the present invention is directed to a solution comprising 85 to 98 wt-% of an aqueous formic acid, said solution having a solids content of 5 to 30% by weight of formylated poly(α(1→3) glucan); wherein the number average molecular weight of the formylated poly(α(1→3) glucan) is at least 10,000 Daltons; and, wherein the degree of formylation of the formylated poly(α(1→3) glucan) lies in the range of 0.1 to 2, preferably 0.5 to 1.5.

In one embodiment, the solids concentration is in the range of 7.5 to 15%.

The poly(α(1→3) glucan) suitable for use in the process of the present invention is a glucan comprising glucose repeat units linked by glycoside linkages whereof ≧50% of said glycoside linkages are α(1→3) glycoside linkages. Suitable poly(α(1→3) glucan) is characterized by a number average molecular weight (Mₙ) of at least 10,000 Da. In one embodiment, ≧90 mol-% of the repeat units in the poly(α(1→3) glucan) are glucose repeat units and ≧50% of the linkages between glucose repeat units are α(1→3) glycoside linkages. Preferably ≧95 mol-%, most preferably 100 mol-%, of the repeat units are glucose repeat units. Preferably ≧90%, of the linkages between glucose units are α(1→3) glycoside linkages.

In one embodiment of the process hereof, the poly(α(1→3) glucan) is characterized by a number average molecular weight of at least 40,000 Da.

The poly(α(1→3) glucan) suitable for the practice of the invention can further comprise repeat units linked by α(1→6) glycoside linkages.

The isolation and purification of various polysaccharides is described in, for example, The Polysaccharides, G. O. Aspinall, Vol. 1, Chap. 2, Academic Press, New York, 1983. Any means for producing the α(1→3) polysaccharide suitable for the invention in satisfactory yield and 90% purity is suitable. In one such method, disclosed in U.S. Pat. No. 7,000,000, poly(α(1→3)-D-glucose) is formed by contacting an aqueous solution of sucrose with gtfJ glucosyltransferase isolated from Streptococcus salivarius according to the methods taught in the art. In an alternative such method, the gtfJ is generated by genetically modified E. Coli, as described in detail, infra.

The aqueous spinning solution hereof is prepared by adding 5 to 20% by weight with respect to the total weight of the solution of a suitable poly(α(1→3) glucan) to a concentrated aqueous solution of formic acid, optionally further comprising 0-10 vol-% of a C₁ or C₂ hydrocarbon or halocarbon. In one embodiment, the hydrocarbon or halocarbon is methylene chloride (MeCl₂). The resulting solution is agitated to obtain thorough mixing. Formylated poly(α(1→3) glucan) is formed in situ under those conditions. When solids content of formylated poly(α(1→3) glucan) is below 5%, the fiber-forming capability of the solution is degraded. Solutions with solids content above 15% are increasingly problematical to form, requiring increasingly aggressive solution-forming techniques.

In any given embodiment, the solubility limit of formylated poly(α(1→3) glucan) is a function of the molecular weight of the formylated poly(α(1→3) glucan), the concentration of the formic acid, the degree of formylation, the duration of mixing, the viscosity of the solution as it is being formed, the shear forces to which the solution is subject, and the temperature at which mixing takes place. Generally, higher shear mixing and higher temperature will be associated with higher solids content. The maximum temperature for mixing is limited to 100° C., the boiling point of the formic acid solution but is preferably kept near ambient temperature (23° C.) to prevent unwanted degradation of the glucan. From the standpoint of solubility and spinnability, the optimum concentrations of the formic acid(aq) and any MeCl₂ may change depending upon the other parameters in the mixing process.

The present invention is further directed to a process comprising causing an aqueous formic acid solution of formylated poly(α(1→3) glucan) to flow through a spinneret, forming a fiber thereby; and, contacting said fiber with a liquid coagulant in which formic acid and it's cosolvent components are miscible, but is a nonsolvent for the formylated poly(α(1→3) glucan).

In one embodiment, MeCl₂ is a component of the liquid coagulant with a concentration in the range of 5-10 wt-%.

In a further embodiment of the process hereof, a suitable poly(α(1→3) glucan) is one wherein 100% of the repeat units are glucose, and >90% of the linkages between glucose repeat units are α(1→3) glycoside linkages.

In the process hereof, the minimum solids content of formylated poly(α(1→3) glucan) required in the solution in order to achieve stable fiber formation varies according to the molecular weight of the formylated poly(α(1→3) glucan), as well as the degree of formylation. It is found in the practice of the invention that a 5% solids content is an approximate lower limit to the concentration needed for stable fiber formation. At >15%, especially >20% solids, excessive amounts of undissolved formylated poly(α(1→3) glucan) tend to be present, causing a degradation in fiber spinning performance. A solution having a solids content of at least 7.5% is preferred. A solids content ranging from about 7.5% to about 15% in 98% aqueous formic acid is more preferred. Preferred is a formylated poly(α(1→3) glucan) characterized by a number average molecular weight of at least 40,000 Da and degree of formylation in the range of 0.1 to 2, preferably 0.5 to 1.5.

Spinning from the solution hereof can be accomplished by means known in the art, and as described in O'Brien, op. cit. The viscous spinning solution can be forced by means such as the push of a piston or the action of a pump through a single or multi-holed spinneret or other form of die. The spinneret holes can be of any cross-sectional shape, including round, flat, multi-lobal, and the like, as are known in the art. The extruded strand can then be passed by ordinary means into a coagulation bath wherein is contained a liquid coagulant which serves to extract the solvent, causing the polymer to coagulate into a fiber.

Suitable liquid coagulants include but are not limited to water or methanol or mixtures thereof. In one embodiment, the liquid coagulant is maintained at a temperature in the range of 0-100° C., and preferably in the range of 15-70° C.

In a preferred embodiment, extrusion is effected directly into the coagulation bath. In such a circumstance, known in the art as “wet-spinning,” the spinneret is partially or fully immersed in the coagulation bath. The spinnerets and associated fittings should be constructed of corrosion resistant alloys such as stainless steel or platinum/gold.

In one embodiment, the thus coagulated fiber is then passed into a second bath provided to neutralize and dilute residual acid from the coagulation bath. The secondary bath preferably contains H₂O, methanol, or 5% aqueous NaHCO₃, or a mixture thereof. Aqueous NaHCO₃ is preferred. In an embodiment, the wound fiber package is soaked in one or more neutralizing wash baths for a period of time up to four hours in each bath. A sequence of baths comprising respectively 5% aqueous NaHCO₃, methanol, and H₂O, has been found satisfactory.

In an alternative embodiment, the secondary bath is eliminated, and the fiber is forwarded directly to the wind-up upon exiting the coagulation bath.

In a further alternative, the secondary bath is replaced by a furnace or oven that can be employed to remove residual low molecular weight species by evaporative extraction, and to heat set or otherwise anneal the coagulated fiber.

In a still further alternative, a furnace can be placed in line between the secondary bath and the wind-up.

The invention hereof is further described in, but not limited by, the following specific embodiments thereof.

### Examples

Materials

| Ingredient | Stock No. | Source |
|---|---|---|
| Sucrose | BDH8029 | VWR |
| Glucose | G7528 | Sigma-Aldrich |
| Dextran T-10 | D9260 | Sigma-Aldrich |
| Boric Acid | B6768 | Sigma-Aldrich |
| NaOH | SX0590-1 | EMD |
| Ethanol | | Sigma-Aldrich |
| Dialysis tubing | Spectrapor 25225-226 | VWR |
| | (12,000 molecular | |
| | weight cut-off) | |
| Anti-foam | Suppressor 7153 | Cognis Corp. |
| Formic Acid | FX0440-6 | EMD Chemicals Inc. |
| (98 wt-% in H₂O) | | |

### Preparation of Glucosyltransferase (GtfJ) Enzyme

### Seed Medium

The seed medium, used to grow the starter cultures for the fermenters, contained: yeast extract (Amberx 695, 5.0 grams per liter (g/L)), K₂HPO₄ (10.0 g/L), KH₂PO₄ (7.0 g/L), sodium citrate dihydrate (1.0 g/L), (NH₄)₂SO₄ (4.0 g/L), MgSO₄ heptahydrate (1.0 g/L) and ferric ammonium citrate (0.10 g/L). The pH of the medium was adjusted to 6.8 using either 5N NaOH or H₂SO₄ and the medium was sterilized in the flask. Post sterilization additions included glucose (20 ml/L of a 50% w/w solution) and ampicillin (4 ml/L of a 25 mg/ml stock solution).

### Fermenter Medium

The growth medium used in the fermenter contained: KH₂PO₄ (3.50 g/L), FeSO₄ heptahydrate (0.05 g/L), MgSO₄ heptahydrate (2.0 g/L), sodium citrate dihydrate (1.90 g/L), yeast extract (Ambrex 695, 5.0 g/L), Suppressor 7153 antifoam (0.25 milliliters per liter, ml/L), NaCl (1.0 g/L), CaCl₂ dihydrate (10 g/L), and NIT trace elements solution (10 ml/L). The NIT trace elements solution contained citric acid monohydrate (10 g/L), MnSO₄ hydrate (2 g/L), NaCl (2 g/L), FeSO₄ heptahydrate (0.5 g/L), ZnSO₄ heptahydrate (0.2 g/L), CuSO₄ pentahydrate (0.02 g/L) and NaMoO₄ dihydrate (0.02 g/L). Post sterilization additions included glucose (12.5 g/L of a 50% w/w solution) and ampicillin (4 ml/L of a 25 mg/ml stock solution).

Construction of Glucosyltransferase (gtfJ) Enzyme Expression Strain

A gene encoding the mature glucosyltransferase enzyme (GtfJ; EC 2.4.1.5; GENBANK® AAA26896.1, SEQ ID NO: 3) from Streptococcus salivarius (ATCC 25975) was synthesized using codons optimized for expression in E. coli (DNA 2.0, Menlo Park Calif.). The nucleic acid product (SEQ ID NO: 1) was subcloned into pJexpress404® (DNA 2.0, Menlo Park Calif.) to generate the plasmid identified as pMP52 (SEQ ID NO: 2). The plasmid pMP52 was used to transform E. coli MG1655 (ATCC 47076) to generate the strain identified as MG1655/pMP52.

Standard recombinant DNA and molecular cloning techniques used herein are well known in the art and are described by Sambrook, J. and Russell, D., Molecular Cloning: A Laboratory Manual, Third Edition, Cold Spring Harbor Laboratory Press, Cold Spring Harbor, N.Y. (2001); and by Silhavy, T. J., Bennan, M. L. and Enquist, L. W., Experiments with Gene Fusions, Cold Spring Harbor Laboratory Press, Cold Spring Harbor, N.Y. (1984); and by Ausubel, F. M. et. al., Short Protocols in Molecular Biology, 5^{th} Ed. Current Protocols, John Wiley and Sons, Inc., N.Y., 2002.

Materials and methods suitable for the maintenance and growth of microbial cultures are well known in the art. Techniques suitable for use in the following examples may be found as set out in Manual of Methods for General Bacteriology (Phillipp Gerhardt, R. G. E. Murray, Ralph N. Costilow, Eugene W. Nester, Willis A. Wood, Noel R. Krieg and G. Briggs Phillips, Eds.), American Society for Microbiology: Washington, D.C. (1994)); or in Manual of Industrial Microbiology and Biotechnology, 3^{rd} Edition (Richard H. Baltz, Julian E. Davies, and Arnold L. Demain Eds.), ASM Press, Washington, D.C., 2010.

Production of Recombinant gtfJ in Fermentation

Production of the recombinant gtfJ enzyme in a fermenter was initiated by expressing the gtfJ enzyme, constructed as described supra. A 10 ml aliquot of the seed medium was added into a 125 ml disposable baffled flask and was inoculated with a 1.0 ml culture of the E. coli MG1655/pMP52 prepared supra, in 20% glycerol. This culture was allowed to grow at 37° C. while shaking at 300 revolutions per minute (rpm) for 3 hours.

A seed culture, for starting the fermenter, was prepared by charging a 2 L shake flask with 0.5 L of the seed medium. 1.0 ml of the pre-seed culture was aseptically transferred into 0.5 L seed medium in the flask and cultivated at 37° C. and 300 rpm for 5 hours. The seed culture was transferred at optical density 550 nm (OD₅₅₀)>2 to a 14 L fermenter (Braun, Perth Amboy, N.J.) containing 8 L of the fermenter medium described above at 37° C.

Cells of E. coli MG1655/pMP52 were allowed to grow in the fermenter and glucose feed (50% w/w glucose solution containing 1% w/w MgSO₄.7H₂O) was initiated when glucose concentration in the medium decreased to 0.5 g/L. The feed was started at 0.36 grams feed per minute (g feed/min) and increased progressively each hour to 0.42, 0.49, 0.57, 0.66, 0.77, 0.90, 1.04, 1.21, 1.41 1.63, 1.92, 2.2 g feed/min respectively. The rate was held constant afterwards by decreasing or temporarily stopping the glucose feed when glucose concentration exceeded 0.1 g/L. Glucose concentration in the medium was monitored using a YSI glucose analyzer (YSI, Yellow Springs, Ohio).

Induction of glucosyltransferase enzyme activity was initiated, when cells reached an OD₅₅₀ of 70, with the addition of 9 ml of 0.5 M IPTG (isopropyl β-D-1-thiogalacto-pyranoside). The dissolved oxygen (DO) concentration was controlled at 25% of air saturation. The DO was controlled first by impeller agitation rate (400 to 1200 rpm) and later by aeration rate (2 to 10 standard liters per minute, slpm). The pH was controlled at 6.8. NH₄OH (14.5% weight/volume, w/v) and H₂SO₄ (20% w/v) were used for pH control. The back pressure was maintained at 0.5 bars. At various intervals (20, 25 and 30 hours), 5 ml of Suppressor 7153 antifoam was added into the fermenter to suppress foaming. Cells were harvested by centrifugation 8 hours post IPTG addition and were stored at −80° C. as a cell paste.

Preparation of gtfJ Crude Enzyme Extract from Cell Paste

The cell paste obtained above was suspended at 150 g/L in 50 mM potassium phosphate buffer pH 7.2 to prepare a slurry. The slurry was homogenized at 12,000 psi (Rannie-type machine, APV-1000 or APV 16.56) and the homogenate chilled to 4° C. With moderately vigorous stirring, 50 g of a floc solution (Aldrich no. 409138, 5% in 50 mM sodium phosphate buffer pH 7.0) was added per liter of cell homogenate. Agitation was reduced to light stirring for 15 minutes. The cell homogenate was then clarified by centrifugation at 4500 rpm for 3 hours at 5-10° C. Supernatant, containing crude gtfJ enzyme extract, was concentrated (approximately 5×) with a 30 kilo Dalton (kDa) cut-off membrane. The concentration of protein in the gftJ enzyme solution was determined by the bicinchoninic acid (BCA) protein assay (Sigma Aldrich) to be 4-8 g/L.

### Preparation of Polymer

Molecular weights were determined by size exclusion chromatography (SEC) with a GPCV/LS 2000™ (Waters Corporation, Milford, Mass.) chromatograph equipped with two Zorbax PSM Bimodal-s silica columns (Agilent, Wilmington, Del.), using DMAc from J. T Baker, Phillipsburg, N.J. with 3.0% LiCl (Aldrich, Milwaukee, Wis.) as the mobile phase. Samples were dissolved in DMAc with 5.0% LiCl.

Molecular weights of the polymers P1-P11, prepared as described infra, are provided in Table 1.

### Polymer P1 (E102989-93)

A twenty-liter aqueous solution was prepared by combining 1000 g of sucrose, 4 g of Dextran T-10, and one liter of potassium phosphate buffer adjusted to pH 6.8-7.0. The pH was adjusted by titrating with a pH meter, using 10% KOH, and the volume was brought up to 20 liters with deionized water. The solution so formed was then charged with 160 ml of the enzyme extract prepared supra and allowed to stand at ambient temperature for 72 hours. The resulting glucan solids were collected on a Buchner funnel using a 325 mesh screen over 40 micrometer filter paper. Following filtration the filter cake then twice underwent a cycle of resuspension in deionized water followed by filtration. The resultant solids then twice underwent a cycle of resuspension in methanol followed by filtration. The resulting filter cake was pressed out on the funnel and dried overnight under vacuum at room temperature. Yield was 138 grams of white flaky solids. Molecular weight is shown in Table 1.

### Polymer P2 (D103029-16E)

A twenty-liter aqueous solution was prepared by combining 1000 g of sucrose, 20 g Dextran T-10, and 370.98 g boric acid (to obtain 300 mM boric acid concentration) and sufficient 4N NaOH solution to adjust the pH to 7.5. The pH was adjusted and the volume brought up to 20 liters with deionized water. The solution was then charged with 200 ml of the enzyme extract prepared supra and allowed to stand at ambient temperature for 48 hours. The resulting glucan solids were collected on a Buchner funnel using a 325 mesh screen over 40 micrometer filter paper. Following filtration the filter cake then four times underwent a cycle of suspension in deionized water followed by filtration. The resultant solids then twice underwent a cycle of resuspension in methanol followed by filtration. The resulting filter cake was pressed out on the funnel and dried in vacuum at 50° C. for more than 12 hours. Yield was 246 grams of white flaky solids. Molecular weight is shown in Table 1.

### Polymer P3 (D103029-16k)

A twenty-liter aqueous solution was prepared by combining 1000 g of sucrose, 2 g of glucose, and 370.98 g boric acid, and sufficient 4N NaOH solution to adjust the pH to 8.0 The pH was adjusted, and the volume was brought up to 20 liters with deionized water. The solution was then charged with 500 ml of the enzyme extract prepared supra and then the solution was cooled to 5° C. using a refrigerated bath and held at that temperature for 60 hours. The resulting glucan solids were collected on a Buchner funnel using a 325 mesh screen over 40 micrometer filter paper. Following filtration the filter cake then five times underwent a cycle of suspension in deionized water followed by filtration. The resultant solids then twice underwent a cycle of suspension in methanol followed by filtration. The filter cake thus prepared was pressed out on the funnel and dried in vacuum at ambient temperature for at least 24 h. Yield was 205 grams of white flaky solids. Molecular weight is shown in Table 1.

### Polymer P4 (D102684-65)

A twenty liter aqueous solution was prepared by combining 1000 g of sucrose, 4 g Dextran T-10, and 136 ml of 50 mM potassium phosphate buffer. All of the ingredients were added in and the pH was adjusted to pH 6.9-7.0 using 10% potassium hydroxide, after which the volume was brought up to 20.6 liters. The solution was then charged with 60 ml of the enzyme extract prepared supra and allowed to stand at ambient temperature for 94 hours. The resulting glucan solids were collected on a Buchner funnel using a 325 mesh screen over 40 micrometer filter paper. The filter cake was suspended in deionized water and filtered twice more as above. Following filtration the filter cake then thrice underwent a cycle of suspension in deionized water followed by filtration. The resultant solids then twice underwent a cycle of suspension in acetone followed by filtration. The filter cake thus prepared was pressed out on the funnel and dried in vacuum at 30° C. Yield was 113 grams of white flaky solids. Molecular weight is shown in Table 1.

### Polymer P5 (D102684-66)

Polymer P5 was prepared as described above for polymer P4. Yield was 101 grams of white flaky solids. Molecular weight is shown in Table 1.

### Polymer P6 (D103029-19A)

A twenty-liter aqueous solution was prepared by combining 1000 g of sucrose, 20 g Dextran T-10, and 370.98 g boric acid, and sufficient 4N NaOH to adjust the pH to 7.5. The pH was adjusted and the volume was brought up to 20 liters with deionized water. The solution was then charged with 200 ml of the enzyme extract prepared supra and allowed to stand at ambient temperature for 48 hours. The resulting glucan solids were collected on a Buchner funnel using a 325 mesh screen over 40 micrometer filter paper. Following filtration the filter cake then four times underwent a cycle of suspension in deionized water followed by filtration. The resultant solids then twice underwent a cycle of suspension in acetone followed by filtration. Yield was 227 grams of white flaky solids.

### Polymer P7 (D103029-19B)

A twenty liter aqueous solution was prepared by combining 1000 g of sucrose, 20 g of Dextran T-10, and 370.98 g of boric acid, and sufficient 4N NaOH solution adjusted to pH 7.5. The pH was adjusted, and the volume was brought up to 20 liters with deionized water. The solution was then charged with 180 ml of the enzyme extract prepared supra and allowed to stand at ambient temperature for 48 hours. The resulting glucan solids were collected on a Buchner funnel using a 325 mesh screen over 40 micrometer filter paper. Following filtration the filter cake then four times underwent a cycle of suspension in deionized water followed by filtration. The resultant solids then twice underwent a cycle of suspension in acetone followed by filtration. The filter cake thus prepared was pressed out on the funnel and dried in vacuum at room temperature. Yield was 229 grams of white flaky solids.

### Polymer P8 (D103032-9)

A twenty liter aqueous solution was prepared by combining 1000 g of sucrose, 27.4 g potassium phosphate, and sufficient 4N NaOH to adjust the pH to 7.0. The pH was adjusted, and the volume brought up to 20 liters with deionized water. The solution was then charged with 500 ml of the enzyme extract prepared supra and stirred at ambient temperature for 24 hours. The resulting glucan solids were collected on a Buchner funnel using a 325 mesh screen over 40 micrometer filter paper. Following filtration the filter cake then four times underwent a cycle of suspension in deionized water followed by filtration. The resultant solids then twice underwent a cycle of suspension in methanol followed by filtration, as well as a suspension in diethyl ether followed by a final filtration. The filter cake was pressed out on the funnel and dried in vacuum at ambient temperature. Yield was 63 grams of white flaky solids. Molecular weight is shown in Table 1.

### Polymer P9 (E116007-29)

Three liters of an aqueous solution was prepared by combining 750 g of sucrose, 9 g of Dextran T-10, 300 ml of undenatured ethanol, and 150 ml of 50 mM potassium phosphate buffer. The pH of the solution so formed was adjusted to pH 6.8-7.0 using 10% potassium hydroxide. The final volume of the solution was brought to three liters by the addition of deionized water. The solution was then charged with 40 ml of the enzyme extract prepared supra and allowed to stand at ambient temperature for 72 hours. The resulting glucan solids were collected on a Buchner funnel using a 325 mesh screen over 40 micrometer filter paper. Following filtration the filter cake then thrice underwent a cycle of suspension in deionized water followed by filtration. The resultant solids then twice underwent a cycle of suspension in methanol followed by filtration. The filter cake so prepared was pressed out on the funnel and dried in vacuum at room temperature. Yield was 138 grams of white flaky solids. Molecular weight is shown in Table 1.

### Polymer P10 (E116007-78)

Three liters of an aqueous solution was prepared by combining 450 g of sucrose, 9 g of Dextran T-10, 300 ml undenatured ethanol, and 150 ml of 50 mM potassium phosphate buffer. The pH of the solution so formed was adjusted to pH 6.8-7.0 using 10% potassium hydroxide. The final volume of the solution was brought to three liters by the addition of deionized water. The solution was then charged with 40 ml of the enzyme extract prepared supra and allowed to stand at ambient temperature for 72 hours. The resulting glucan solids were collected on a Buchner funnel using a 325 mesh screen over 40 micrometer filter paper. Following filtration the filter cake then twice underwent a cycle of suspension in deionized water followed by filtration. The resultant solids then twice underwent a cycle of suspension in methanol followed by filtration. Following that, the solids were suspended in diethyl ether, again followed by filtration. The filter cake thus prepared was pressed out on the funnel and dried in vacuum at room temperature. Yield was 56 grams of white flaky solids. Molecular weight is shown in Table 1.

### Polymer P11 (SSL8475-1)

### D102639-008 Method:

In a 150 gallon glass lined reactor equipped with stirring and temperature control, approximately 265 L of deionized water were added to 32.5 kg of sucrose, 0.7 kg of potassium hydrogen phosphate, and 9.27 kg of boric acid. The pH was adjusted to 7.8-8.0 using 16% NaOH (11 kg). The solution so formed was then charged with 760 ml of the enzyme extract prepared supra, followed by the addition of sufficient deionized water to bring the final volume to 500 liters. The reactants were then mixed at 25° C. for 48 hours using a paddle stirrer in the reaction vessel at <100 rpm. After 48 hours, the reactants were heated to 50° C. for 30 minutes and then allowed to cool. The resulting glucan solids were transferred to a Zwag filter and the mother liquor removed. The cake was washed via displacement with water 4 times with approximately 65 liters of water in each step. Finally two additional displacement washes each with 65 liters of methanol were carried out. The material was dried under vacuum at 60° C. Yield was: 6.5 kg of white flaky solids. Molecular weight is shown in Table 1.

TABLE 1

| | Mn Polymer | Mw Polymer |
|---|---|---|
| POLYMER | (×10⁻⁴) | (×10⁻⁴) |
| P1 | 12.1 | 23.9 |
| P2 | 13.0 | 27.0 |
| P3 | 6.5 | 18.5 |
| P4 | 11.4 | 28.0 |
| P5 | 12.4 | 31.1 |
| P6 | 12.2 | 26.3 |
| P7 | 13.2 | 30.1 |
| P8 | 4.1 | 15.2 |
| P9 | 8.4 | 15.8 |
| P10 | ND | ND |
| P11 | 7.0 | 15.2 |

### Spinning Solutions and Fiber Spinning

Spinning Solutions

For each Fiber Example, the corresponding spinning solution was prepared by charging a polyethylene zip lock bag with the polymer and the appropriate amount of solvent to prepare approximately 200 ml of solution having the PAG solids content indicated in Table 2. The composition of the solvent is shown in Table 2. In Table 2 the notation 90/10 v/v 98% FA/H₂O means that, e.g., to make up 200 ml of solvent 180 ml of 98% formic acid (aq) as received was combined with 20 ml of water. Similarly, 95/5 w/w 98% FA/H₂O means that 95% by weight of 98% (aq) formic acid was combined with 5% by weight of additional H₂O to make up 200 ml of solvent, The solution was then kneaded by hand in the sealed bag to break up any aggregated chunks and then allowed to stand at room temperature overnight. The following day the partially dissolved solution (clear but containing a small amount of visible particulate) was transferred into a spin cell containing screen packs including 100 and 325 mesh stainless steel screens. A piston was fitted into the top of the spin cell, over the viscous mixture. Using a motorized worm gear to drive the piston, the mixture was then pumped through the screens into an identically equipped spinning cell coupled head to head with the first cell via a coupler fabricated from ¼ inch stainless steel tubing. The mixture was thus pumped back and forth through 13 cycles. Approximately 20 hours after preparation the solution thus prepared was fed to the spinning apparatus, described infra.

TABLE 2
SPINNING SOLUTIONS

| FIBER | Bobbin number | POLYMER | | | |
|---|---|---|---|---|---|
| EXAMPLE | (Example #) | REF. | POLYMER | SOLVENT | % SOLIDS |
| 1 | E102989-120-5 | 102989-93 | P1 | 90/10 v/v 98% FA/MeCl₂ | 10 |
| 2 | E117890-50-1 | D102639-16E | P2 | 95/5 w/w 98% FA/H₂O | 11.0 |
| 3 | E117890-52-6 | D102639-16E | P2 | 95/5 w/w 98% FA/H₂O | 11.0 |
| 4 | E117890-56-5 | D102639-16K | P3 | 95/5 w/w 98% FA/H₂O | 11.0 |
| 5 | E117890-144-5 | D102639-16K | P3 | 95/5 w/w 98% FA/H₂O | 11.0 |
| 6 | E117890-54-5 | D102684-65 | P4 | 95/5 w/w 98% FA/H2O | 11.0 |
| 7 | E117890-65-5 | D102684-66 | P5 | 90/10 w/w 98% FA/H2O | 15.0 |
| 8 | E117890-60-2 | D102684-66 | P5 | 95/5 w/w 98% FA/H2O | 15.0 |
| 9 | E117890-83-5 | D103029-19A | P6 | 98% FA | 12.0 |
| 10 | E117890-82-4 | D103029-19A | P6 | 90/10 w/w 98% FA/MeCl2 | 12.0 |
| 11 | E117890-87-3 | D103029-19A | P6 | 90/10 w/w 98% FA/MeCl2 | 16.0 |
| 12 | E117890-88-8 | D103029-19A | P6 | 90/10 w/w 98% FA/MeCl2 | 16.0 |
| 13 | E117890-113-8 | D103029-19B | P7 | 90/10 w/w 98% FA/TFA | 11.0 |
| 14 | E117890-104-10 | D103029-19B | P7 | 98% FA/ZnCl2/MeCl₂ | 11.0 |
| 15 | E117976-10-2 | D103032-9 mix | P8 | 92/8 v/v 98% FA/H2O | 17 |
| 16 | E117976-10-6 | D103032-9 mix | P8 | 92/8 v/v 98% FA/H2O | 17 |
| 17 | E117890-90-6 | E116007-29 | P9 | 98% FA | 16.0 |
| 18 | E116007-50-1 | E116007-41 | P9 | 90/10 v/v 98% FA/MeCl₂ | 17 |
| 19 | E116007-54-5 | E116007-41 | P9 | 90/10 v/v 98% FA MeCl₂ | 19 |
| 20 | E116007-86-4 | E116007-78 | P10 | 90/10 v/v 98% FA/MeCl₂ | 19 |
| 21 | E117890-78-4 | SSL 8475 Run 1 | P11 | 90/10 w/w 98% FA/MeCl₂ | 14.0 |
| 22 | E117976-92-5 | SSL 8475 Run 1 | P11 | 95/5 w/w FA/H₂O | 13 |
| 23 | E117890-66-4 | SSL 8475 Run 1 | P11 | 95/5 w/w 98% FA/H₂O | 13.0 |
| 24 | E117890-74-3 | SSL 8475 Run 1 | P11 | 98% FA | 11.0 |

### Spinning Apparatus and Procedure

Glossary of Terms

| Column | | |
|---|---|---|
| Label | Actual Term | Explanation |
| Jet Vel. | Jet Velocity | The linear speed of the fiber at |
| (fpm) | | the exit from the spinneret. |
| fpm | Feet per minute | |
| Coag. | Coagulation | |
| Temp. | Temperature | |
| NA | Not Applicable | The parameter does not apply to this example. |
| NT | Not Tested | |
| S.S.F. | Spin Stretch | S.S.F. = (wind-up speed)/(jet vel.) |
| | Factor | |
| MeOH | Methanol | |
| D.F. | Degree of | Average extent to which pendant hydroxyls |
| | formylation | in the PAG were replaced by formate. |
| | | Theoretical maximum = 3. |

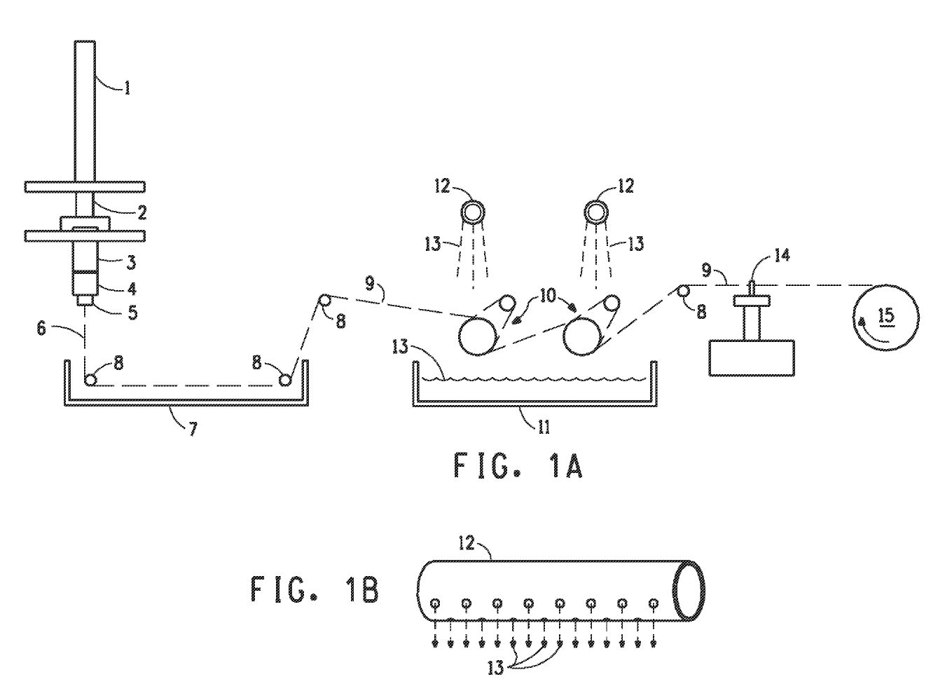

FIG. 1A is a schematic diagram of the apparatus employed in the fiber spinning process hereof. The worm gear drive, 1, drove a ram, 2, at a controlled rate onto a piston fitted into a spinning cell, 3. The spinning cell contained filter assemblies including 100 and 325 mesh stainless steel screens. A spin pack, 4, contained the spinneret, 5, and optionally stainless steel screens as prefilters for the spinneret. The spinneret had one or a plurality of holes, the number being indicated in Table 3. Each spinneret hole was characterized by a length and a diameter, shown in Table 3. While the process hereof is not limited thereby, the spinneret holes were circular in cross-section. The extruded filament, 6, produced therefrom was directed into a liquid coagulation bath, 7. As indicated in Table 3, the filament was extruded from the spinneret either through a short air gap or directly into the liquid coagulation bath—the bottom of the spinneret was immersed in the bath, indicated by an air gap of 0 in.

The extrudate can be, but need not be, directed back and forth through the bath between guides, 8, which are normally fabricated of Teflon® PTFE. Only one pass through the bath is shown in FIG. 1. On exiting the coagulation bath, 7, the thus quenched filament, 9, was optionally, as indicated in Table 3, directed through a drawing zone using independently driven rolls, 10, around which the thus quenched filament was wrapped. The quenched filament was optionally directed through a draw bath, 11, or a furnace, as indicated in Table 3 that allowed further treatment such as additional solvent extraction, washing or drawing of the extruded filaments. The draw bath contained a liquid, 13, comprising water or methanol. The thus prepared filament was then directed through a traversing mechanism, 14, to evenly distribute the fiber on the bobbin, and collected on plastic bobbins using a wind up, 15. The draw rolls, 10, were run at different speeds to allow for drawing of the fiber prior to the wind up, 15. The draw rolls, 10, were in contact with the secondary bath liquid, 13, and were washed continuously with a spray of liquid, 13, using the perforated tubing spray assemblies, 12, shown in detail in FIG. 1B.

In some examples, one or both of the driven rolls, 10, was removed from the fiber pathway, but the fiber was nevertheless immersed in the draw bath. The two were independent of each other.

In some examples, a plurality of filaments was extruded through a multi-hole spinneret, and the filaments so produced were converged to form a yarn. In a further embodiment, the process further comprises a plurality of multi-hole spinnerets so that a plurality of yarns can be prepared simultaneously.

In each example, the wound bobbin of fiber produced was soaked overnight in a bucket of the liquid indicated in Table 2. The thus soaked bobbin of fiber was then air dried for at least 24 hours.

The spin cell, the piston, the connecting tubing and the spinneret were all constructed of stainless steel.

### Fiber Physical Property Measurement.

Physical properties such as tenacity, elongation and initial modulus were measured using methods and instruments conforming to ASTM Standard D 2101-82, except that the test specimen length was 10 inches. Reported results are averages for 5-10 individual yarn tests.

The physical properties were determined for every fiber prepared. The results are shown in Table 4. Included are the denier of the fiber produced, and the physical properties such as tenacity (T) in grams per denier (gpd), elongation to break (E, %), and initial modulus (M) in gpd.

TABLE 3

| | SPINNING PROCESS | | | | | | | | |
|---|---|---|---|---|---|---|---|---|---|
| | | Hole | Hole | Pump | Jet | Air | QUENCH BATH | | |
| Fiber | # | Diameter | Length | Rate | Velocity | Gap | | Length | Temperature |
| Example | Holes | (in) | (in) | (ml/min) | (fpm) | (in) | Liquid | (ft) | (° C.) |
| 1 | 1 | 0.010 | | 0.30 | 5 | 0 | MeOH | 3 | 10 |
| 2 | 20 | 0.003 | 0.012 | 1.50 | 55 | 0 | MeOH | 4.5 | 25 |
| 3 | 1 | 0.003 | 0.006 | 3.15 | 110 | 0.75 | H2O | 4.5 | 19 |
| 4 | 20 | 0.004 | | 3.20 | 64 | 0 | H2O | 4.5 | 16 |
| 5 | 40 | 0.003 | | 1.70 | 60 | 0 | H2O | 4.5 | 19 |
| 6 | 20 | 0.003 | 0.006 | 4.20 | 150 | 0 | H2O | 4.33 | 19 |
| 7 | 6 | 0.003 | | 0.85 | 102 | 0.75 | H2O | 4 | 15 |
| 8 | 20 | 0.003 | 0.006 | 2.10 | 75 | 0 | H2O | 4.5 | 15 |
| 9 | 20 | 0.003 | 0.006 | 2.70 | 95 | 0.625 | H2O | 4.2 | 14 |
| 10 | 20 | 0.003 | 0.006 | 2.70 | 95 | 0.5 | H2O | 4.2 | 15 |
| 11 | 20 | 0.003 | 0.006 | 2.30 | 85 | 0 | H2O | 4.4 | 14 |
| 12 | 20 | 0.003 | 0.006 | 2.30 | 85 | 0 | H2O | 4.4 | 13 |
| 13 | 20 | 0.004 | 0.016 | 3.15 | 64 | 0 | H2O | 4.2 | 38 |
| 14 | 20 | 0.003 | 0.006 | 1.28 | 45 | 0 | MeOH | 8 | 21 |
| 15 | 20 | 0.003 | 0.010 | 1.6 | 57 | 0 | H2O | 4.2 | 19 |
| 16 | 20 | 0.005 | 0.010 | 2.16 | 27 | 1.5 | H2O | 4.2 | 18 |
| 17 | 20 | 0.004 | 0.016 | 2.10 | 42 | 0 | H2O | 4.33 | 14 |
| 18 | 20 | 0.005 | 0.010 | 1.60 | 21 | 0.5 | MeOH | 4.2 | −9 |
| 19 | 20 | 0.005 | 0.010 | 2.65 | 34 | 1 | MeOH | 4.2 | −4 |
| 20 | 20 | 0.003 | 0.010 | 1.50 | 57 | 0.625 | MeOH | 11.8 | 3 |
| 21 | 20 | 0.003 | 0.006 | 1.60 | 58 | 1 | H2O | 4.2 | 15 |
| 22 | 20 | 0.005 | 0.010 | 900 | 24 | 0.5 | H2O | 0.5 | 9 |
| 23 | 20 | 0.003 | 0.006 | 1.58 | 55 | 0 | H2O | 4.25 | 15 |
| 24 | 20 | 0.003 | 0.006 | 3.15 | 64 | 0 | H2O | 4.25 | 15 |

| | DRAW | | | | | | | |
|---|---|---|---|---|---|---|---|---|
| | 1st Draw | 2nd Draw | | | | | | |
| | Roll | Roll | 2ND QUENCH | | | Wind-up | | Post- |
| Fiber | Speed | Speed | | Length | Temperature | Speed | | Spinning |
| Example | (fpm) | (fpm) | Type | (ft) | ° C. | (fpm) | S.S.F. | Soak |
| 1 | na | na | na | na | na | 32 | 6.6 | MeOH |
| 2 | na | na | na | na | na | 76 | 1.4 | MeOH/ |
| | | | | | | | | H2O |
| | | | | | | | | soak |
| 3 | 42 | na | MeOH | 1.92 | 25 | 68 | 0.6 | MeOH |
| 4 | 45 | na | MeOH | 2.00 | 15 | 65 | 1.0 | MeOH |
| 5 | na | na | Furnace | 1 | 560 | 60 | 1.0 | Bicarb/ |
| | | | | | | | | MeOH |
| 6 | 128 | na | na | na | na | 128 | 0.9 | MeOH |
| 7 | 116 | na | na | na | na | 116 | 1.1 | MeOH |
| 8 | 56 | na | H2O | 2.30 | 72 | 72 | 1.0 | MeOH |
| 9 | 43 | na | Furnace | 1 | 450 | 67 | 0.7 | H2O |
| 10 | 48 | na | Furnace | 1 | 260 | 65 | 0.7 | MeOH |
| 11 | 57 | na | Furnace | 1 | 541 | 72 | 0.8 | MeOH |
| 12 | 43 | na | Furnace | 1 | 1000 | 55 | 0.6 | MeOH |
| 13 | na | na | MeOH | 2 | 19 | 110 | 1.7 | MeOH |
| 14 | 71 | na | na | na | na | 78 | 1.7 | 5% |
| | | | | | | | | sodium |
| | | | | | | | | bicarb, |
| | | | | | | | | then |
| | | | | | | | | H2O |
| 15 | 75 | na | na | na | na | 80 | 1.4 | MeOH |
| 16 | 40 | na | MeOH | 2.25 | 16 | 49 | 1.8 | MeOH |
| 17 | 46 | na | Furnace | 1 | 900 | 73 | 1.7 | H2O |
| 18 | 18 | na | na | na | na | 20 | 1.0 | H2O |
| 19 | 33 | na | na | na | na | 45 | 1.3 | MeOH |
| 20 | 32 | na | H2O | 2.67 | 35 | 42 | 0.7 | MeOH |
| 21 | 50 | na | MeOH | 2 | 15 | 63 | 1.1 | MeOH |
| 22 | 30 | 35 | H2O | drip | 56 | 36 | 1.5 | MeOH |
| 23 | 62 | na | H2O | 2.30 | 84 | 70 | 1.3 | MeOH |
| 24 | 60 | na | H2O | 2.10 | 80 | 70 | 1.1 | MeOH |

TABLE 4

| | T | E | M | | |
|---|---|---|---|---|---|
| EXAMPLE | (gpd) | (%) | (gpd) | DENIER | DOF |
| 1 | 1.2 | 25.7 | 31 | 23 | — |
| 2 | 1.6 | 6.3 | 91 | 60 | — |
| 3 | 1.4 | 10.1 | 43 | 35 | — |
| 4 | 1.1 | 3.7 | 43 | 230 | 1.37 |
| 5 | 1.2 | 4.1 | 68 | 219 | — |
| 6 | 1.8 | 4.3 | 67 | 100 | — |
| 7 | 1.6 | 3.8 | 69 | 120 | 1.07 |
| 8 | 1.5 | 5.4 | 48 | 180 | — |
| 9 | 1.6 | 5.2 | 71 | 187 | — |
| 10 | 1.4 | 5.3 | 52 | 200 | — |
| 11 | 1.4 | 5.1 | 50 | 215 | — |
| 12 | 1.4 | 5.9 | 54 | 270 | — |
| 13 | 1.1 | 13.6 | 37 | 105 | 1.19 |
| 14 | 1.2 | 5.1 | 49 | 75 | 0.60 |
| 15 | 1.6 | 4.2 | 67 | 65 | — |
| 16 | 1.5 | 6.5 | 59 | 245 | — |
| 17 | 1.1 | 3.2 | 48 | 215 | — |
| 18 | 1.3 | 10.7 | 56 | 292 | — |
| 19 | 1.5 | 5.6 | 75 | 400 | — |
| 20 | 1.2 | 7.5 | 46 | 300 | — |
| 21 | 1.6 | 3.7 | 69 | 115 | 1.41 |
| 22 | 1.4 | 6.3 | 51 | 375 | — |
| 23 | 1.2 | 3.8 | 57 | 125 | 1.24 |
| 24 | 1.3 | 5.2 | 52 | 140 | — |

I claim:

1. An aqueous solution comprising 85 to 98% by weight of formic acid and a solids content of 5 to 30% by weight of formylated poly(α(1→3) glucan) comprising glucose and formylated glucose repeat units linked by glycoside linkages whereof ≧50% of said glycoside linkages are α(1→3) glycoside linkages; wherein the number average molecular weight of the formylated poly(α(1→3) glucan) is at least 10,000 Daltons; and, wherein the degree of formylation of the formylated poly(α(1→3) glucan) lies in the range of 0.1 to 2.

2. The solution of claim 1 wherein the solids content of formylated poly(α(1→3) glucan) is in the range of 7 to 20%.

3. The solution of claim 1 wherein the degree of formylation is in the range of 1.0 to 1.5.

4. The solution of claim 1 wherein the formylated poly(α(1→3) glucan) comprises glucose and formylated glucose repeat units linked by glycoside linkages whereof ≧90% of said glycoside linkages are α(1→3) glycoside linkages >90% of the linkages between glucose repeat units are α(1→3) glycoside linkages. Many of the polymers in the examples are primed with Dextran and will, therefore contain some 1-6 linkages.

5. The solution of claim 1 wherein the formylated poly(α(1→3) glucan) further comprises glucose and formylated glucose repeat units linked by α(1→6) glycoside linkages.

6. The solution of claim 1 wherein the number average molecular weight of the formylated poly(α(1→3) glucan) is at least 40,000 Daltons.

7. The solution of claim 1 further comprising methylene chloride.

8. A process comprising forming a spinning solution by dissolving into an aqueous solution of 85 to 98% formic acid, 5 to 20% by weight of the total weight of the spinning solution so formed, of poly(α(1→3) glucan), thereby preparing formylated poly(α(1→3) glucan) comprising glucose and formylated glucose repeat units linked by glycoside linkages whereof ≧50% of said glycoside linkages are α(1-3) glycoside linkages; wherein the number average molecular weight of the formylated poly(α(1→3) glucan) is at least 10,000 Da; and, wherein the degree of formylation of the formylated poly(α(1→3) glucan) so formed lies in the range of 0.1 to 2; causing said solution to flow through a spinneret, forming a fiber thereby; and contacting said fiber with a liquid coagulant.

9. The process of claim 8 wherein 7 to 20% by weight of poly(α(1→3) glucan) is dissolved in said spinning solution.

10. The process of claim 8 wherein the liquid coagulant is water or methanol.

11. The process of claim 8 wherein the spinning solution further comprises methylene chloride.

12. The process of claim 8 wherein the poly(α(1→3) glucan) 100% of the repeat units are glucose, and ≧90% of the linkages between repeat units are α(1→3) glycoside linkages.

13. The process of claim 8 wherein the formylated poly(α(1→3) glucan) further comprises glucose and formylated glucose repeat units linked by α(1→6) glycoside linkages.

14. The process of claim 8 wherein the poly(α(1→3) glucan) is characterized by a number average molecular weight of at least 40,000 Daltons.

15. A fiber comprising formylated poly(α(1→3) glucan) comprising glucose and formylated glucose repeat units linked by glycoside linkages whereof ≧50% of said glycoside linkages are α(1→3) glycoside linkages; wherein the number average molecular weight of the formylated poly(α(1→3) glucan) is at least 10,000 Daltons, and wherein the degree of formylation of the formylated poly(α(1→3) glucan) lies in the range of 0.1 to 2.

16. The fiber of claim 15 wherein the degree of formylation is in the range of 1.0 to 1.5.

17. The fiber of claim 15 wherein the formylated poly(α(1→3) glucan) ≧90% of the linkages between glucose repeat units are α(1→3) glycoside linkages.

18. The fiber of claim 15 wherein the number average molecular weight of the formylated poly(α(1→3) glucan) is at least 40,000 Daltons.

19. The fiber of claim 15 wherein the formylated poly(α(1→3) glucan) further comprises glucose and formylated glucose repeat units linked by α(1→6) glycoside linkages.

20. A multifilament yarn comprising the fiber of claim 15.
